(19) United States
(12) Patent Application Publication
(10) Pub. No.: US 2025/0118840 A1
(43) Pub. Date: Apr. 10, 2025

(54) BATTERY SUB-MODULE FOR A MOTOR VEHICLE

(71) Applicant: PLASTIC OMNIUM CLEAN ENERGY SYSTEMS RESEARCH, Lyon (FR)

(72) Inventors: Nicolas DERANGERE, Bruxelles (BE); Pierre OSZWALD, Bruxelles (BE); Franck DHAUSSY, Bruxelles (BE)

(73) Assignee: PLASTIC OMNIUM CLEAN ENERGY SYSTEMS RESEARCH, Lyon (FR)

(21) Appl. No.: 18/717,740

(22) PCT Filed: Dec. 21, 2022
(86) PCT No.: PCT/EP2022/087368

§ 371 Date: Jun. 7, 2024

(30) Foreign Application Priority Data
Dec. 22, 2021 (FR) 2114257

(51) Int. Cl. H01M 50/211; H01M 10/6551; H01M 50/293; H01M 50/507; H01M 50/516

(52) U.S. Cl. CPC H01M 50/211; H01M 10/6551; H01M 50/293; H01M 50/507; H01M 50/516; H01M 2220/20

(57) ABSTRACT

The invention relates to a battery sub-module (11) for a motor vehicle, the sub-module comprising two battery cells in pouch form and a carrier frame (33), each battery cell comprising two electrodes (37, 38; 39, 40), each electrode (37, 38, 39, 40) protruding from the carrier frame (33), a first electrode (37) of the first battery cell being such that, outside the carrier frame (33), it faces a first electrode (39) of the second battery cell and is connected to said first electrode (39) by a welded connection, the second electrode (38) of the first battery cell being such that, outside the carrier frame (33), it faces a second electrode (40) of the second battery cell and is connected to said second electrode (40) by a welded connection. The invention also relates to a battery module for a motor vehicle, the module comprising a plurality of battery sub-modules of the aforementioned type.

The invention relates to a battery sub-module for a motor vehicle, a battery module comprising such battery sub-modules, a battery assembly comprising such battery modules, a motor vehicle comprising such a battery assembly, a method of mounting such a battery sub-module, and a method of mounting such a battery module.

Already known in the state of the art is a battery assembly comprising a plurality of battery modules each comprising battery cells in pouch form. Such a battery assembly is used, for example, in a battery electric vehicle (BEV).

However, the manufacture and assembly of said battery modules is relatively complex, particular due to the fact that the battery cells in pouch form are flexible, making them difficult to handle when mounting the battery modules. Furthermore, the battery cells in pouch form can be easily damaged, for example during storage or handling thereof prior to mounting.

To overcome these disadvantages, it is known to produce battery sub-modules comprising several battery cells in pouch form, for example as disclosed in WO 2020/111665 A1 or US 2021/057692 A1. However, the assembly of these battery sub-modules is relatively complex, particularly with regard to maintaining the battery cells in pouch form in said battery sub-modules.

The object of the invention is especially to simplify the assembly of a battery sub-module.

To this end, the invention relates to a battery sub-module for a motor vehicle, comprising a cell stack comprising, stacked along a stacking axis E:
a first battery cell in pouch form,
a second battery cell in pouch form,
a layer of compressible material, inserted between the first battery cell and second battery cell,
the battery sub-module comprising a plastic carrier frame, which at least partially surrounds the first battery cell, the layer of compressible material and the second battery cell,
each battery cell comprising two electrodes opposite each other transversely to the stacking axis E,
each electrode protruding from the carrier frame,
a first electrode of the first battery cell being such that, outside the carrier frame, it faces a first electrode of the second battery cell and is connected to the first electrode of the second battery cell by a welded connection, the second electrode of the first battery cell being such that, outside the carrier frame, it faces the second electrode of the second battery cell and is connected to the second electrode of the second battery cell by a welded connection,
the carrier frame being partially arranged between the first electrode of the first battery cell and the first electrode of the second battery cell, and
the carrier frame being partially arranged between the second electrode of the first battery cell and the second electrode of the second battery cell, and preferably, the carrier frame carrying the first battery cell, the layer of compressible material and the second battery cell.

In this way, the carrier frame carries the cell stack solely by means of welded connections. More specifically, the battery cells in pouch form and the layer of compressible material inserted therebetween are maintained in position on the carrier frame by means of welded connections. This thus eliminates the need for additional elements to attach the stacking elements to the carrier frame. As a result, the battery cells are easily maintained in position, thus simplifying the assembly of the battery sub-module. Furthermore, such an assembly can be easily dismantled in order to reuse or recycle the constituent components thereof.

The term “battery cell in pouch form” or “pouch cell battery” is understood to mean that, in accordance with the usual meaning of this term in the field of batteries, electrolyte and electrodes are accommodated in the internal space of the pouch cell battery, with a pouch-like envelope surrounding said internal space. The envelope includes, for example, an outer insulating layer, a metal layer and, optionally, an inner adhesive layer. The outer insulating layer prevents permeation of external moisture and/or gas, and is made of a polymeric material, for example. The metal layer improves the mechanical strength of the envelope. The metal layer is made of aluminum, for example. Alternatively, the metal layer is, for example, formed either of an alloy of iron, carbon, chromium and manganese, or of steel, or nickel, or a nickel alloy or aluminum. The electrodes protrude from the envelope in the form of conductive tabs, the envelope being sealed around these conductive tabs, which thus form the electrodes of the pouch cell battery when the pouch cell battery is assembled. Preferably, the pouch cell battery is rectangular in shape.

“Layer of compressible material” is particularly understood to mean that the layer of compressible material is more compressible along the stacking axis E than the other elements of the cell stack, namely the first battery cell and the second battery cell.

According to other optional features of the battery sub-module, taken either alone or in combination:
The carrier frame carries exactly two battery cells, namely the first battery cell and the second battery cell.
The carrier frame carries the cell stack solely by means of the welded connection connecting the first electrode of the first battery cell to the first electrode of the second battery cell, and the welded connection connecting the second electrode of the first battery cell to the second electrode of the second battery cell.
The first battery cell, the second battery cell and the layer of compressible material are maintained in position on the carrier frame by means of the welded connection connecting the first electrode of the first battery cell to the first electrode of the second battery cell, and the welded connection connecting the second electrode of the first battery cell to the second electrode of the second battery cell.
The layer of compressible material is configured to absorb expansion along the stacking axis E of the first battery cell and the second battery cell, and the compressible material layer is thermally insulating, such that it is configured to thermally protect the first battery cell and the second battery cell from each other. In this way, the layer of compressible material simultaneously and simply fulfills the function of absorbing the expansion of the battery cells and the function of thermally protecting the battery cells from each other.
The compressible material layer is selected from the group consisting of a foam layer and a polymer-based strip. The use of a foam layer as a compressible material layer thus helps to limit the mass of the battery sub-module and is particularly economical. Alternatively, using a polymer-based strip as the compressible material layer facilitates the application of the compressible material layer.
The compressible material layer is fire-resistant. Fire-resistant is understood to mean, for example, resistant to temperatures in excess of 200° C., and preferably compliant with standard UL94V0. Thus, in the event of ignition of one of the first and second battery cells, the other battery cell is protected.
The compressible material layer is silicone-based.
The compressible material layer has a Shore A hardness of between 20 and 50. Shore A hardness is, for example, measured in accordance with standard ASTM D-2240.
The compressible material layer has a density of between 0.5 and 1.0 g/cm³. Density is, for example, measured in accordance with standard ASTM D-792.
The carrier frame is made of a thermoplastic material. Thus, the carrier frame is particularly simple and economical to manufacture.
The carrier frame is injection-molded. Thus, the carrier frame is particularly simple and economical to manufacture.
The carrier frame, first battery cell and second battery cell are rectangular in shape. Thus, the shape of the carrier frame corresponds to the shape of the battery cells, which limits the movement of the battery cells in the carrier frame. Furthermore, this facilitates assembly as the movement of the cell stack is limited by the carrier frame before the welded joints are made.
The layer of compressible material is coated with adhesive on both sides along the stacking axis E, to maintain the layer of compressible material in contact with the first battery cell and with the second battery cell. Thus, this facilitates assembly as the cellular stack can be maintained in place, albeit loosely, before the welded joints are made.
The battery sub-module comprises a heat sink plate, which is arranged at one end of the cell stack, the heat sink plate and the carrier frame being attached together via attachment means.
The heat sink plate is L-shaped such that one edge of the battery sub-module, running parallel to the stacking axis E, is predominantly formed by the heat sink plate. Thus, despite the use of a plastic carrier frame, heat dissipation is improved by dissipation or cooling via the edge of the battery sub-module formed predominantly by the heat sink plate.
One edge of the battery sub-module, running parallel to the stacking axis E, is formed preferably at least 75%, more preferentially at least 90%, by the heat sink plate. This further improves heat dissipation.
The heat sink plate is made of aluminum. Thus, the material used for the heat sink plate is lightweight, a good thermal conductor and fire-resistant.
The heat sink plate is coated with adhesive on its inner face in order to maintain the heat sink plate in contact with the first battery cell or with the second battery cell. Thus, this facilitates assembly as the cellular stack can be maintained, albeit loosely, on the heat sink plate and therefore on the carrier frame, before the welded connections are made.
The attachment means comprise clamps and/or clips and/or counter-forms, arranged on the carrier frame and/or the second battery cell and/or the heat sink plate. Thus, this makes attaching the heat sink plate particularly simple.
The heat sink plate is clamped or snapped onto the carrier frame. Thus, this makes attaching the heat sink plate particularly simple.
The heat sink plate has snap-in tabs that snap into the carrier frame. This makes attaching the heat sink plate to the carrier frame particularly simple.
The battery sub-module comprises a first busbar, the first electrode of the first battery cell being welded directly to the first busbar, and the first electrode of the second battery cell being welded directly to the first busbar. Thus, the electrical connection between the first electrodes and the first busbar is produced in a simple and safe manner.
The battery sub-module comprises a second busbar, the second electrode of the first battery cell being welded directly to the second busbar, and the second electrode of the second battery cell being welded directly to the second busbar. Thus, the electrical connection between the second electrodes and the second busbar is produced in a simple and safe manner.
The first busbar is attached to the carrier frame. Thus, the mounting of the first busbar is carried out in a simple manner.
The first busbar is clamped or snapped onto the carrier frame. Thus, the mounting of the first busbar is carried out in a particularly simple manner.
The first busbar comprises lugs, which are clamped onto the carrier frame.
The second busbar is attached to the carrier frame. Thus, the mounting of the second busbar is carried out in a particularly simple manner.
The second busbar is clamped or snapped onto the carrier frame. Thus, the mounting of the second busbar is carried out in a particularly simple manner.
The second busbar comprises lugs which are clamped onto the carrier frame.
The distance, outside the carrier frame, between the first electrode of the first battery cell and the first electrode of the second battery cell is greater than the distance in the carrier frame between the first electrode of the first battery cell and the first electrode of the second battery cell. Thus, during assembly, the welding of the first electrodes to the first busbar is facilitated.
The distance, outside the carrier frame, between the second electrode of the first battery cell and the second electrode of the second battery cell is greater than the distance in the carrier frame between the second electrode of the first battery cell and the second electrode of the second battery cell. Thus, during assembly, the welding of the second electrodes to the second busbar is facilitated.
The first electrode of the first battery cell is welded directly to the first electrode of the second battery cell. Thus, the electrical connection between the first electrodes is produced in a particularly simple and safe manner.
The second electrode of the first battery cell is welded directly to the second electrode of the second battery cell. Thus, the electrical connection between the second electrodes is produced in a particularly simple and safe manner.
The electrodes on each battery cell differ from one another. Thus, when assembling the battery sub-module, said difference prevents a battery cell from being mounted the wrong way round, by means of the foolproofing effect on the electrodes. This simplifies battery sub-module assembly.
Taken along the stacking axis E, the total thickness of the carrier frame is less than the total thickness of the cell stack and the heat sink plate. Thus, this makes it easier to compress the battery cells when mounting the battery sub-module in a battery module.
The carrier frame comprises foolproofing means, formed by a protruding element and a recessed element of complementary shape to the protruding element, the protruding element and the recessed element being oriented on the same axis parallel to the stacking axis E, the protruding element and the recessed element being arranged at a distance from the center of the cell stack along the stacking axis E and opposite each other. These foolproofing means thus simplify the assembly of several battery sub-modules therebetween. This therefore makes it easier and safer to assemble a battery module comprising several identical battery sub-modules.
The carrier frame comprises four different, asymmetrical edges. Thus, when assembling the battery sub-module, these differences prevent incorrect mounting of the carrier frame by means of the foolproofing effect. This simplifies battery sub-module assembly.

The invention also relates to a battery module for a motor vehicle, comprising several battery sub-modules as defined above, the battery sub-modules being stacked along the stacking axis E so as to form a row of battery sub-modules, the battery module comprising an attachment plate at each end of the row of battery sub-modules, the attachment plates being interconnected by axial compression means along the stacking axis E, the axial compression means axially compressing the row of battery sub-modules.

Thus, a battery module is produced in a simple and particularly compact manner.

According to other optional features of the battery module, taken either alone or in combination:
The battery sub-modules forming the row of battery sub-modules are identical.
The battery sub-modules are electrically interconnected.
The first electrodes of the row of battery sub-modules are electrically interconnected by welding an electrical connection, and the second electrodes of the row of battery sub-modules are electrically interconnected by welding an electrical connection.
The axial compression means comprise at least one threaded rod. Thus, the axial compression means are produced in a simple and economical manner.
The attachment plates are made of reinforced plastic, preferably fiber-reinforced, or are made of metal, preferably aluminum.
The projecting element of one battery sub-module is inserted into a recessed element of an adjacent battery sub-module. Thus, a mounting error is reliably avoided, and the foolproofing function when assembling the battery module is achieved.
The battery module is configured to transfer heat to a cooling plate, with each heat sink plate in heat transfer mode with the cooling plate. For example, heat transfer is achieved by direct contact or indirect contact by means of a thermally conductive paste.

The invention also relates to a battery assembly comprising several battery modules as defined above, preferably several rows of battery modules as defined above.

The invention also relates to a motor vehicle, preferably a battery electric vehicle, comprising a battery assembly as previously defined, and preferably a cooling plate, each battery module of the battery assembly being configured to transfer heat to the cooling plate.

The invention also relates to a method of mounting a battery sub-module as previously defined, which comprises the following steps:
arranging a plastic carrier frame,
producing a cell stack comprising, stacked along a stacking axis E, a first battery cell in pouch form, a second battery cell in pouch form, and a layer of compressible material inserted between the first battery cell and the second battery cell, the cell stack being arranged in the carrier frame,
creating a welded connection between a first electrode of the first battery cell and a first electrode of the second battery cell,
creating a welded connection between a second electrode of the first battery cell and a second electrode of the second battery cell.

According to other optional features of the method of mounting a battery sub-module, taken either alone or in combination:
The method of mounting a battery sub-module comprises the following step: attaching a heat sink plate to one end of the cell stack, such that the heat sink plate and the carrier frame are attached relative to each other.
The method of mounting a battery sub-module comprises the following step: prior to the step of making the welded connection between the first electrode of the first battery cell and the first electrode of the second battery cell, attaching a first busbar to the carrier frame.
The method of mounting a battery sub-module comprises the following step: prior to the step of making the welded connection between the second electrode of the first battery cell and the second electrode of the second battery cell, attaching a second busbar to the carrier frame.
The welded connection between the first electrode of the first battery cell and the first electrode of the second battery cell is achieved by welding between the first electrode of the first battery cell and the first busbar, and by welding between the first electrode of the second battery cell and the first busbar, preferably by laser welding.
The welded connection between the second electrode of the first battery cell and the second electrode of the second battery cell is achieved by welding between the second electrode of the first battery cell and the second busbar, and by welding between the second electrode of the second battery cell and the second busbar, preferably by laser welding.
The method of mounting a battery sub-module comprises the following step: after making the welded connections, cutting off the free ends of the electrodes projecting from the first busbar or the second busbar.
The welded connection between the first electrode of the first battery cell and the first electrode of the second battery cell is achieved by direct welding between the first electrode of the first battery cell and the first electrode of the second battery cell, preferably by laser welding. To enable welding without damaging the carrier frame, a finger of a tool is inserted, outside the carrier frame, between the first electrode of the first battery cell and the first electrode of the second battery cell. The first electrode of the first battery cell is folded over the finger such that it is in contact with the first electrode of the second battery cell, and welding is carried out between the first electrode of the first battery cell and the first electrode of the second battery cell. Alternatively, the first electrode of the second battery cell is folded over the finger such that it is in contact with the first electrode of the first battery cell, and welding is carried out between the first electrode of the first battery cell and the first electrode of the second battery cell.
The welded connection between the second electrode of the first battery cell and the second electrode of the second battery cell is achieved by direct welding between the second electrode of the first battery cell and the second electrode of the second battery cell, preferably by laser welding. To enable welding without damaging the carrier frame, a finger is inserted, outside the carrier frame, between the second electrode of the first battery cell and the second electrode of the second battery cell. The second electrode of the first battery cell is folded over the finger such that it is in contact with the second electrode of the second battery cell, and welding is carried out between the second electrode of the first battery cell and the second electrode of the second battery cell. Alternatively, the second electrode of the second battery cell is folded over the finger such that it is in contact with the second electrode of the first battery cell, and welding is carried out between the second electrode of the first battery cell and the second electrode of the second battery cell.

The invention also relates to a method of mounting a battery module as previously defined, which comprises the following steps:
stacking several battery sub-modules as previously defined along a stacking axis E to form a row of battery sub-modules,
arranging an attachment plate at each end of the row of battery sub-modules,
mounting axial compression means along the stacking axis E in order to connect the attachment plates together and thus axially compress the row of battery sub-modules.

According to other optional features of the method of mounting a battery module, taken either alone or in combination:
After the step of mounting the axial compression means, the method of mounting a battery module comprises the following step: electrically connecting the battery sub-modules together by welding via their first electrodes and/or their first busbars, and/or by welding via their second electrodes and/or their second busbars.

### BRIEF DESCRIPTION OF THE FIGURES

The invention will be better understood upon reading the following description, which is provided merely as example and with reference to the appended drawings, wherein:

FIG. 1 is a schematic view of a motor vehicle comprising a battery assembly comprising several battery modules;

FIG. 2 is a perspective view of a battery module, which comprises several battery sub-modules according to a first embodiment;

FIG. 3 is a perspective exploded view of a cell stack forming part of a battery sub-module according to the first embodiment;

FIG. 4 is a perspective view of a battery sub-module according to the first embodiment;

FIG. 5 is a perspective exploded view of a detail of the battery sub-module shown in FIG. 4;

FIG. 6 is a perspective view of a carrier frame forming part of the battery sub-module shown in FIG. 4;

FIG. 7 is a perspective exploded view of a detail of a battery sub-module according to a second embodiment.

### DETAILED DESCRIPTION

In all the figures, the same references relate to the same elements.

In this detailed description, the following embodiments are examples. Although the description refers to one or more embodiments, this does not mean that the features apply only to a single embodiment. Simple features of different embodiments can also be combined and/or interchanged to provide other embodiments.

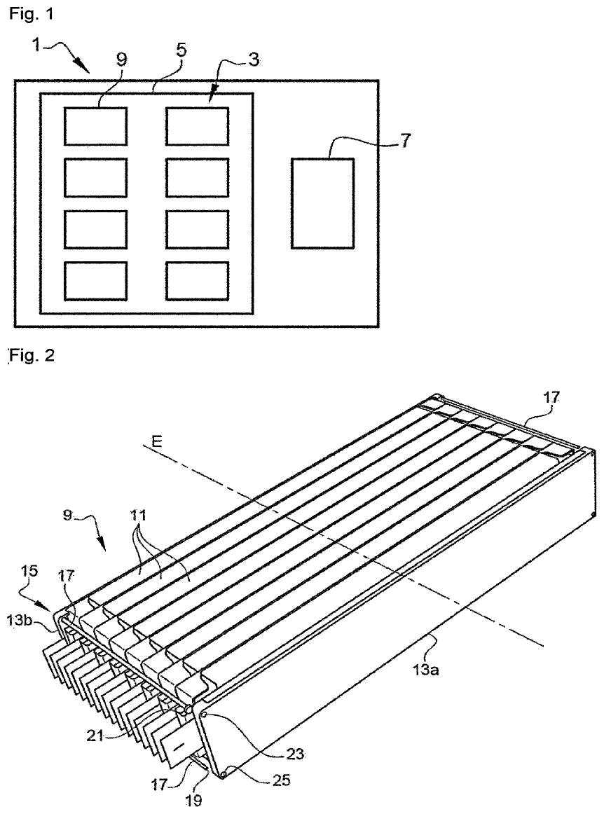

FIG. 1 schematically shows a motor vehicle 1 comprising a battery assembly 3 and a cooling plate 5. In this example, the motor vehicle 1 is a battery electric vehicle and thus comprises an electric motor 7 configured to drive the movement of the motor vehicle 1.

The battery assembly 3 comprises several battery modules 9. More specifically, in this example, the battery assembly 3 comprises several rows of battery modules 9, preferably two rows of four battery modules 9 as shown in FIG. 1. Each battery module 9 of the battery assembly 3 is configured to transfer heat to the cooling plate 5.

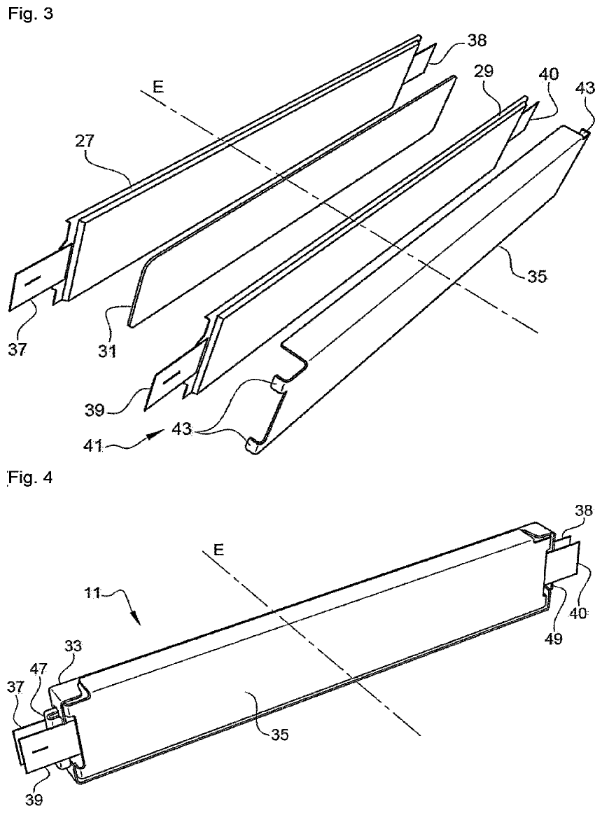

As shown in FIG. 2, a battery module 9 comprises several battery sub-modules 11. The battery sub-modules 11 are stacked along a stacking axis E so as to form a row of battery sub-modules 11. In this example, the battery module 9 comprises eight battery sub-modules 11, and the battery sub-modules 11 forming the battery sub-module row 11 are identical. The battery module 9 comprises an attachment plate 13a, 13b at each end of the row of battery sub-modules 11.

The attachment plates 13a, 13b are made of reinforced plastic, preferably fiber-reinforced, or are made of metal, preferably aluminum.

The attachment plates 13a, 13b are interconnected by axial compression means 15 along the stacking axis E, the axial compression means 15 axially compressing the row of battery sub-modules 11. The axial compression means 15 comprise at least one threaded rod 17. More specifically in this example, as shown in FIG. 2, the axial compression means 15 comprise four threaded rods 17.

Each threaded rod 17 extends along the stacking axis E and comprises a threaded end 19 for connection to one of the two attachment plates 13a, 13b and a bearing head 21 on the other of the two attachment plates 13a, 13b, in order to enable axial compression along the stacking axis E. Of these two attachment plates 13a, 13b, one comprises a through-hole 23 for the threaded rod 17, the other comprises a connecting hole 25 wherein the threaded end 19 is engaged. The bearing head 21 rests against the through-hole 23.

As shown in FIG. 3 in particular, a battery sub-module 11 comprises a cell stack comprising, stacked along the stacking axis E:
a first battery cell 27 in pouch form,
a second battery cell 29 in pouch form, and
a layer of compressible material 31, inserted between the first battery cell 27 and the second battery cell 29.

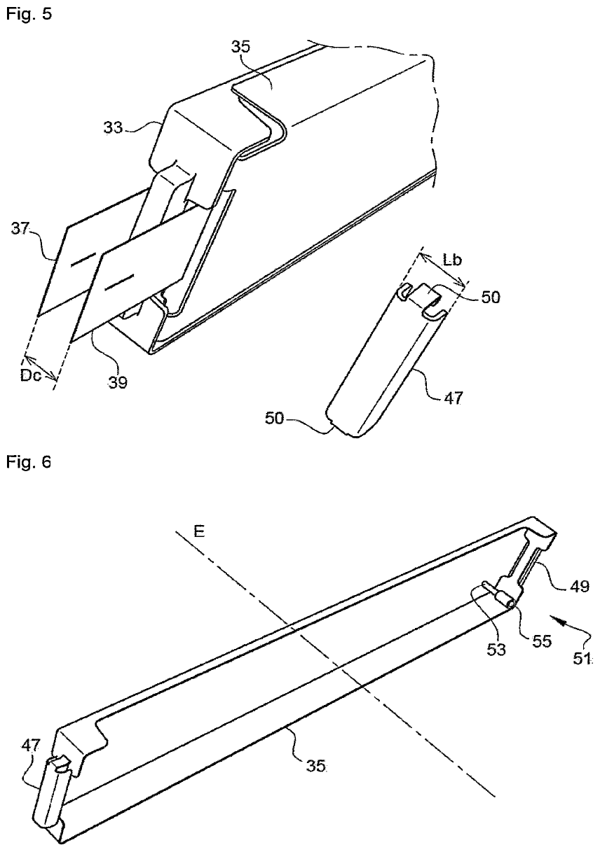

The battery sub-module 11 also comprises a carrier frame 33 made of plastic material, shown in particular in FIGS. 3 and 5. As shown in FIG. 4, the carrier frame 33 at least partially surrounds the first battery cell 27, the layer of compressible material 31 and the second battery cell 29. More specifically, the carrier frame 33 carries the first battery cell 27, the layer of compressible material 31 and the second battery cell 29. Thus, in this example, the carrier frame 33 carries exactly two battery cells, namely the first battery cell 27 and the second battery cell 29. In this example, the carrier frame 33, the first battery cell 27 and the second battery cell 29 are rectangular in shape. The carrier frame 33 is made of a thermoplastic material and is injection-molded.

The battery sub-module 11 further comprises a heat sink plate 35, which is arranged at one end of the cell stack.

As shown in FIG. 4 in particular, the first battery cell 27 comprises two electrodes 37, 38 opposite one another transversely to the stacking axis E, and the second battery cell 29 comprises two electrodes 39, 40 opposite one another transversely to the stacking axis E. Each electrode 37, 38, 39, 40 is, for example, a tab formed by a metal sheet, preferably aluminum.

Each electrode 37, 38, 39, 40 protrudes from the carrier frame 33. A first electrode 37 of the first battery cell 27 faces a first electrode 39 of the second battery cell 29, outside the carrier frame 33, and is connected to the first electrode 39 of the second battery cell 29 by a welded connection. Outside the carrier frame, the second electrode 38 of the first battery cell 27 faces the second electrode 40 of the second battery cell 29 and is connected by a welded connection to the second electrode 40 of the second battery cell 29. Thus, the carrier frame 33 carries the cell stack solely by means of the welded connection connecting the first electrode 37 of the first battery cell 27 to the first electrode 39 of the second battery cell 29, and the welded connection connecting the second electrode 38 of the first battery cell 27 to the second electrode 40 of the second battery cell 29. In other words, the first battery cell 27, the second battery cell 29 and the compressible material layer 31 are maintained in position on the carrier frame 33 by means of the welded connection connecting the first electrode 37 of the first battery cell 27 to the first electrode 39 of the second battery cell 29, and the welded connection connecting the second electrode 38 of the first battery cell 27 to the second electrode 40 of the second battery cell 29.

The carrier frame 33 is partially arranged between the first electrode 37 of the first battery cell 27 and the first electrode 39 of the second battery cell 29, and the carrier frame 33 is partially arranged between the second electrode 38 of the first battery cell 27 and the second electrode 40 of the second battery cell 29. Taken along the stacking axis E, the total thickness of the carrier frame 33 is less than the total thickness of the cell stack and the heat sink plate 35. Thus, this makes it easier to compress the battery cells 27, 29 when mounting the battery sub-module 11 in a battery module 9.

In this example, the electrodes 37, 38, 39, 40 each pass through an indentation in the carrier frame 33, and parts of the carrier frame 33, tapered along the stacking axis E as a result of these indentations, protrude outwards transversely to the stacking axis E in the form of lugs extending on either side of the carrier frame 33.

In this example, the electrodes 37, 38, 39, 40 of each battery cell 27, 29 differ from one another. Thus, as shown particularly in FIG. 5, a marking on the first electrode 37 of the first battery cell 27 differentiates it from the second electrode 38 of the first battery cell 27. Similarly, a marking on the first electrode 39 of the second battery cell 29 differentiates it from the second electrode 40 of the second battery cell 29. In this example, said markings consist of a “-” line. In a variant not shown, the carrier frame 33 comprises four different, asymmetrical edges.

As shown in FIG. 3, the layer of compressible material 31, inserted between the first battery cell 27 and the second battery cell 29, is configured to absorb expansion along the stacking axis E of the first battery cell 27 and the second battery cell 29. In addition, the compressible material layer 31 is thermally insulating, such that it is configured to thermally protect the first battery cell 27 and the second battery cell 29 from each other, and the compressible material layer 31 is fire-resistant.

In this example, the compressible material layer 31 is selected from the group consisting of a foam layer and a polymer-based strip. Preferably, the layer of compressible material 31 is silicone-based, has a Shore A hardness of between 20 and 50, and has a density of between 0.5 and 1.0 g/cm³. In this example, the layer of compressible material 31 is coated with adhesive on both sides along the stacking axis E, in order to maintain the layer of compressible material 31 in contact with the first battery cell 27 and with the second battery cell 29.

In this example, the heat sink plate 35 is made of aluminum and the inner face of the heat sink plate 35 is in contact with the outer face of the second battery cell 29.

Furthermore, the heat sink plate 35 is L-shaped such that an edge of the battery sub-module 11, running parallel to the stacking direction X, is predominantly formed by the heat sink plate 35. In FIGS. 2, 3, 4 and 6, the aforementioned edge of the battery sub-module 11 is the top edge. More specifically in this example, said edge of the battery sub-module 11, running parallel to the stacking axis E, is preferably at least 75%, more preferentially at least 90%, formed by the heat sink plate 35, as shown in particular in FIG. 4. Said edge of the battery sub-module 11 is configured to transfer heat to the cooling plate 5.

The heat sink plate 35 is also coated with adhesive on its inner face, in order to maintain the heat sink plate 35 in contact with the second battery cell 29.

The heat sink plate 35 and the carrier frame 33 are attached to each other by attachment means 41. Thus, the heat sink plate 35 is clamped or snapped onto the carrier frame 33.

As shown in FIG. 3 in particular, the attachment means 41 comprise clamping lugs 43 and/or clips and/or counter-forms, arranged on the carrier frame 33 and/or the second battery cell 29 and/or the heat sink plate 35. More specifically in this example, the heat sink plate 35 is clamped to the carrier frame 33, and the attachment means 41 comprise clamping lugs 43 arranged on the heat sink plate 35. These clamping lugs 43 are inserted into the carrier frame 33 by elastic deformation and thus maintain the heat sink plate 35 and the carrier frame 33 securely together. Alternatively, in a variant not shown, the heat sink plate 35 is snap-fastened to the carrier frame 33, and the heat sink plate 35 comprises snap-fastening lugs snapped into the carrier frame 33.

Thus, the battery module 9 is configured to transfer heat to the cooling plate 5, with each heat sink plate 35 in heat transfer mode with the cooling plate 5. For example, heat transfer is achieved by direct contact or indirect contact by means of a thermally conductive paste.

The battery sub-module 11 also comprises a first busbar 47, the first electrode 37 of the first battery cell 27 being welded directly to the first busbar 47, and the first electrode 39 of the second battery cell 29 being welded directly to the first busbar 47.

The battery sub-module 11 also comprises a second busbar 49, the second electrode 38 of the first battery cell 27 being welded directly to the second busbar 49, and the second electrode 40 of the second battery cell 29 being welded directly to the second busbar 49.

The first busbar 47 is clamped or snapped onto the carrier frame 33. In this example, the first busbar 47 comprises lugs 50, which are clamped onto the carrier frame 33. More specifically, the first busbar 47 has a complementary shape to the part of the carrier frame 33 extending between the first electrode 37 of the first battery cell 27 and the first electrode 39 of the second battery cell 29. Said part of the carrier frame 33 is tapered along the stacking axis E and protrudes outwards transversely to the stacking axis E in the form of an ear.

In this example, the second busbar 49 is identical to the first busbar 47. Thus, the second busbar 49 is clamped or snapped onto the carrier frame 33, and the second busbar 49 comprises lugs 50, which are clamped onto the carrier frame 33. More specifically, the second busbar 49 has a complementary shape to the part of the carrier frame 33 extending between the second electrode 38 of the first battery cell 27 and the second electrode 40 of the second battery cell 29. Said part of the carrier frame 33 is tapered along the stacking axis E and protrudes outwards transversely to the stacking axis E in the form of an ear.

The first busbar 47 and the second busbar 49 are electrically conductive, and are made of copper or aluminum, for example.

The distance, outside the carrier frame 33, between the first electrode 37 of the first battery cell 27 and the first electrode 39 of the second battery cell 29 is greater than the distance in the carrier frame 33 between the first electrode 37 of the first battery cell 27 and the first electrode 39 of the second battery cell 29. In other words, before assembling the battery sub-module 11, the width Lb of the first busbar 47 is greater than the distance Dc between the first electrode 37 of the first battery cell 27 and the first electrode 39 of the second battery cell, as shown in FIG. 5. Similarly, the distance, outside the carrier frame 33, between the second electrode 38 of the first battery cell 27 and the second electrode 40 of the second battery cell 29 is greater than the distance in the carrier frame 33 between the second electrode 38 of the first battery cell 27 and the second electrode 40 of the second battery cell 29. In other words, before assembling the battery sub-module 11, the width of the second busbar 49 is greater than the distance between the second electrode 38 of the first battery cell 27 and the second electrode 40 of the second battery cell.

As shown in FIG. 6, the carrier frame 33 also comprises foolproofing means 51, formed by a protruding element 53 and a recessed element 55 of complementary shape to the protruding element 53, the protruding element 53 and the recessed element 55 being oriented on the same axis parallel to the stacking axis E, the protruding element 53 and the recessed element 55 being arranged at a distance from the center of the cell stack along the stacking axis E and opposite each other. In this example, the protruding element 53 is a pin, and the recessed element 55 is a female connector.

Thus, in a battery module 9, the protruding element 53 of a battery sub-module 11 is inserted into a recessed element 55 of an adjacent battery sub-module 11.

Furthermore, in a battery module 9, the battery sub-modules 11 are electrically interconnected. For example, the first electrodes 37, 39 of the row of battery sub-modules 11 are electrically interconnected by welding an electrical connection, and the second electrodes 38, 40 of the row of battery sub-modules 11 are electrically interconnected by welding an electrical connection. The electrical connections are welded, for example, by folding the first electrodes 37, 39, respectively the second electrodes 38, 40, onto each other and then laser welding. Alternatively, a first electrical connecting bar is brought into contact with the first busbars 47 and welded thereto by laser welding, and a second electrical connecting bar is brought into contact with the second busbars 49 and welded thereto by laser welding.

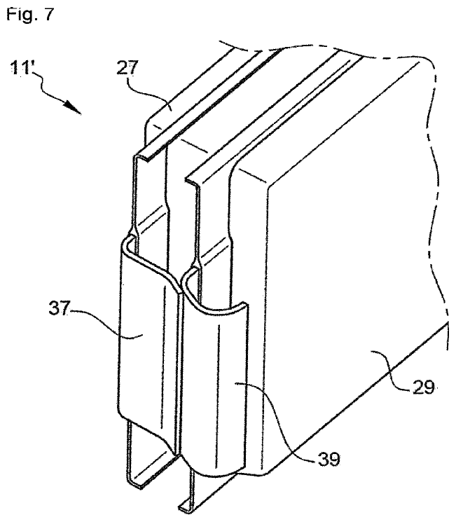

FIG. 7 shows a detail of a battery sub-module 11′ according to a second embodiment. In FIG. 7, only the first battery cell 27 and the second battery cell 29 are shown, to facilitate understanding of the structure of the battery sub-module 11′. This battery sub-module 11′ according to the second embodiment differs from the battery sub-module 11 according to the first embodiment described above in that it does not comprise a busbar. In fact, in said second embodiment, the first electrode 37 of the first battery cell 27 is welded directly to the first electrode 39 of the second battery cell 29. Similarly, although not shown, the second electrode 38 of the first battery cell 27 is welded directly to the second electrode 40 of the second battery cell 29.

An example of a method for mounting a battery sub-module 11, 11′ as defined above is described below. Such a mounting method comprises the following steps:
arranging a plastic carrier frame 33,
producing a cell stack comprising, stacked along a stacking axis E, a first battery cell 27 in pouch form, a second battery cell 29 in pouch form, and a layer of compressible material 31 inserted between the first battery cell 27 and the second battery cell 29, the cell stack being arranged in the carrier frame 33,
creating a welded connection between a first electrode 37 of the first battery cell 27 and a first electrode 39 of the second battery cell 29,
creating a welded connection between a second electrode 38 of the first battery cell 27 and a second electrode 40 of the second battery cell 29.

The method of mounting a battery sub-module 11, 11′ also comprises the following step: attaching a heat sink plate 35 to one end of the cell stack, such that the heat sink plate 35 and the carrier frame 33 are attached relative to each other.

The method of mounting a battery sub-module 11 according to the first embodiment also comprises the following step: prior to the step of making the welded connection between the first electrode 37 of the first battery cell 27 and the first electrode 39 of the second battery cell 29, attaching a first busbar 47 to the carrier frame 33. The welded connection between the first electrode 37 of the first battery cell 27 and the first electrode 39 of the second battery cell 29 is achieved by welding between the first electrode 37 of the first battery cell 27 and the first busbar 47, and by welding between the first electrode 39 of the second battery cell 29 and the first busbar 47, preferably by laser welding.

The method of mounting a battery sub-module 11 according to the first embodiment also comprises the following step: prior to the step of making the welded connection between the second electrode 38 of the first battery cell 27 and the second electrode 40 of the second battery cell 29, attaching a second busbar 49 to the carrier frame 33. The welded connection between the second electrode 38 of the first battery cell 27 and the second electrode 40 of the second battery cell 29 is achieved by welding between the second electrode 38 of the first battery cell 27 and the second busbar 49, and by welding between the second electrode 40 of the second battery cell 29 and the second busbar 49, preferably by laser welding.

According to a variant not shown, the method of mounting a battery sub-module 11 according to the first embodiment also comprises the following step: after making the welded connections, cutting off the free ends of the electrodes 37, 38, 39, 40 protruding from the first busbar 47 or the second busbar 49.

The method of mounting a battery sub-module 11′ according to the second embodiment also comprises the following feature: the welded connection between the first electrode 37 of the first battery cell 27 and the first electrode 39 of the second battery cell 29 is achieved by direct welding between the first electrode 37 of the first battery cell 27 and the first electrode 39 of the second battery cell 29, preferably by laser welding.

To enable welding without damaging the carrier frame 33, a finger is inserted, outside the carrier frame 33, between the first electrode 37 of the first battery cell 27 and the first electrode 39 of the second battery cell 29. The first electrode 37 of the first battery cell 27 is folded over the finger such that it is in contact with the first electrode 39 of the second battery cell 29, and welding is carried out between the first electrode 37 of the first battery cell 27 and the first electrode 39 of the second battery cell 29. Alternatively, according to a variant not shown, the first electrode 39 of the second battery cell 29 is folded over the finger such that it is in contact with the first electrode 37 of the first battery cell 27, and welding is carried out between the first electrode 37 of the first battery cell 27 and the first electrode 39 of the second battery cell 29.

Similarly, although not shown, the method of mounting a battery sub-module 11′ according to the second embodiment also comprises the following feature: the welded connection between the second electrode 38 of the first battery cell 27 and the second electrode 40 of the second battery cell 29 is achieved by direct welding between the second electrode 38 of the first battery cell 27 and the second electrode 40 of the second battery cell 29, preferably by laser welding.

To enable welding without damaging the carrier frame, a finger is inserted, outside the carrier frame 33, between the second electrode 38 of the first battery cell 27 and the second electrode 40 of the second battery cell 29. The second electrode 38 of the first battery cell 27 is folded over the finger such that it is in contact with the second electrode 40 of the second battery cell 29, and welding is carried out between the second electrode 38 of the first battery cell 27 and the second electrode 40 of the second battery cell 29.

Alternatively, according to a variant not shown, the second electrode 40 of the second battery cell 29 is folded over the finger such that it is in contact with the second electrode 38 of the first battery cell 27, and welding is carried out between the second electrode 38 of the first battery cell 27 and the second electrode 40 of the second battery cell 29.

An example of a method of mounting a battery module 9 as previously defined is described below. Such a mounting method comprises the following steps:
stacking several battery sub-modules 11, 11′ as previously defined along a stacking axis E to form a row of battery sub-modules 11, 11′,
arranging an attachment plate 13a, 13b at each end of the row of battery sub-modules 11, 11′,
mounting axial compression means 15 along the stacking axis E to connect the attachment plates 13a, 13b together and thus axially compress the row of battery sub-modules 11, 11′.

After the step of mounting the axial compression means 15, the method of mounting a battery module also comprises the following step: electrically connecting the battery sub-modules 11, 11′ together by welding via their first electrodes 37, 39 and/or their first busbars 47, and/or by welding via their second electrodes 38, 40 and/or their second busbars 49.

The invention is not limited to the embodiments presented, and other embodiments will become clearly apparent to the person skilled in the art.

It is possible, in particular, to combine the first and second embodiments in such a way that a battery sub-module comprises a first busbar 47 connecting the first electrode 37 of the first battery cell 27 and the first electrode 39 of the second battery cell 29, and that the second electrode 38 of the first battery cell 27 is welded directly to the second electrode 40 of the second battery cell 29, or such that a battery sub-module comprises a second busbar 49 connecting the second electrode 38 of the first battery cell 27 and the second electrode 40 of the second battery cell 29, and that the first electrode 37 of the first battery cell 27 is welded directly to the first electrode 39 of the second battery cell 29.

### LIST OF REFERENCES

1: motor vehicle
3: battery assembly
5: cooling plate
7: electric motor
9: battery module
11, 11′: battery sub-module
13a, 13b: attachment plate
15: axial compression means
17: threaded rod
19: threaded end
21: bearing head
23: through-hole
25: connecting hole
27: first battery cell
29: second battery cell
31: layer of compressible material
33: carrier frame
35: heat sink plate
37, 38, 39, 40: electrode
41: attachment means
43: clamping lug
47: first busbar
49: second busbar
50: lug
51: foolproofing means
53: protruding element
55: recessed element
E: stacking axis
Lb: width
Dc: distance

1. A battery sub-module (11, 11′) for a motor vehicle (1), comprising a cell stack comprising, stacked along a stacking axis E:
a first battery cell (27) in pouch form,
a second battery cell (29) in pouch form,
a layer of compressible material (31), inserted between the first battery cell (27) and the second battery cell (29),
the battery sub-module (11, 11′) comprising a carrier frame (33) made of plastic material, which at least partially surrounds the first battery cell (27), the layer of compressible material (31) and the second battery cell (29),
the carrier frame (33) carrying the first battery cell (27), the layer of compressible material (31) and the second battery cell (29),
each battery cell (27, 29) comprising two electrodes (37, 38; 39, 40) opposite each other transversely to the stacking axis E,
each electrode (37, 38, 39, 40) protruding from the carrier frame (33),
a first electrode (37) of the first battery cell (27) being such that, outside the carrier frame (33), it faces a first electrode (39) of the second battery cell (29) and is connected to the first electrode (39) of the second battery cell (29) by a welded connection, the second electrode (38) of the first battery cell (27) being such that, outside the carrier frame (33), it faces the second electrode (40) of the second battery cell (29) and is connected to the second electrode (40) of the second battery cell (29) by a welded connection,
characterized in that
the carrier frame (33) is partially arranged between the first electrode (37) of the first battery cell (27) and the first electrode (39) of the second battery cell (29),
and in that
the carrier frame (33) is partially arranged between the second electrode (38) of the first battery cell (27) and the second electrode (40) of the second battery cell (29).

2. The battery sub-module (11, 11′) according to the preceding claim, wherein the layer of compressible material (31) is configured to absorb expansion along the stacking axis E of the first battery cell (27) and the second battery cell (29), and wherein the layer of compressible material (31) is thermally insulating, such that it is configured to thermally protect the first battery cell (27) and the second battery cell (29) from each other, and wherein the compressible material layer (31) is selected from the group consisting of a foam layer and a polymer-based strip.

3. The battery sub-module (11, 11′) according to any of the preceding claims, comprising a heat sink plate (35), which is arranged at one end of the cell stack,
the heat sink plate (35) and the carrier frame (33) being attached together by attachment means (41),
wherein the heat sink plate (35) is L-shaped, such that an edge of the sub-module, running parallel to the stacking axis E, is predominantly formed by the heat sink plate (35).

4. The battery sub-module (11) according to any of the preceding claims, which comprises a first busbar (47), the first electrode (37) of the first battery cell (27) being welded directly to the first busbar (47), and the first electrode (39) of the second battery cell (29) being welded directly to the first busbar (47).

5. The battery sub-module (11) according to the preceding claim, wherein the first busbar (47) is attached to the carrier frame (33).

6. The battery sub-module (11) according to any of the preceding claims, wherein the distance, outside the carrier frame (33), between the first electrode (37) of the first battery cell (27) and the first electrode (39) of the second battery cell (29) is greater than the distance, in the carrier frame (33), between the first electrode (37) of the first battery cell (27) and the first electrode (39) of the second battery cell (29).

7. The battery sub-module (11′) according to any of the preceding claims, wherein the second electrode (38) of the first battery cell (27) is welded directly to the second electrode (40) of the second battery cell (29).

8. The battery sub-module (11, 11′) according to any of the preceding claims, wherein, taken along the stacking axis E, the total thickness of the carrier frame (33) is less than the total thickness of the cell stack and the heat sink plate (35).

9. The battery sub-module (11, 11′) according to any of the preceding claims, wherein the carrier frame (33) comprises foolproofing means (51), formed by a protruding element (53) and a recessed element (55) of complementary shape to the protruding element (53), the protruding element (53) and the recessed element (55) being oriented on the same axis parallel to the stacking axis E, the protruding element (53) and the recessed element (55) being arranged at a distance from the center of the cell stack along the stacking axis E and opposite each other.

10. The battery sub-module (11, 11′) according to any of the preceding claims, wherein the carrier frame (33) carries exactly two battery cells, namely the first battery cell (27) and the second battery cell (29).

11. The battery sub-module (11, 11′) according to any of the preceding claims, wherein the carrier frame (33) carries the cell stack solely by virtue of:
the welded connection connecting the first electrode (37) of the first battery cell (27) and the first electrode (39) of the second battery cell (29), and by virtue of
the welded connection connecting the second electrode (38) of the first battery cell (27) and the second electrode (40) of the second battery cell (29).

12. The battery sub-module (11, 11′) according to any of the preceding claims, wherein the first battery cell (27), the second battery cell (29) and the layer of compressible material (31) are maintained in position on the carrier frame (33) by means of:
the welded connection connecting the first electrode (37) of the first battery cell (27) and the first electrode (39) of the second battery cell (29), and of
the welded connection connecting the second electrode (38) of the first battery cell (27) and the second electrode (40) of the second battery cell (29).

13. A battery module (9) for a motor vehicle (1), comprising several battery sub-modules (11, 11′) according to any one of the preceding claims, the battery sub-modules (11, 11′) being stacked along the stacking axis E so as to form a row of battery sub-modules (11, 11′),
the battery module (9) comprising an attachment plate (13a, 13b) at each end of the row of battery sub-modules (11, 11′), the attachment plates (13a, 13b) being interconnected by axial compression means (15) along the stacking axis E, the axial compression means (15) axially compressing the row of battery sub-modules (11, 11′).
